(19) United States
(12) Patent Application Publication
(10) Pub. No.: US 2007/0000075 A1
(43) Pub. Date: Jan. 4, 2007

(54) Multifunctional textile-pretreating agent

(76) Inventor: Manfred Jungen, LAUWIL BI (CH)

Correspondence Address: CLARIANT CORPORATION;INTELLECTUAL PROPERTY DEPARTMENT, 4000 MONROE ROAD, CHARLOTTE, NC, 28205, US

(21) Appl. No.: 10/569,335

(22) PCT Filed: Aug. 13, 2004
(86) PCT No.: PCT/IB04/02689

§ 371 Date: Feb. 21, 2006

(30) Foreign Application Priority Data
Aug. 21, 2003 (CH) 01426/03

(51) Int. Cl. C09B 67/00

(52) U.S. Cl. 8/609

(57) ABSTRACT

The present invention relates to a multifunctional textile-pretreating agent which has a bleaching, wetting and stabilizing action and provides a good washing and sequestering effect. Particularly the combination of two different alkoxylates with hydroxy carboxylic acids, sulphonates and phosphonates leads to an all-in-one product requiring only a very small amount of solubilizer, if any.

The present invention relates to a multifunctional textile-pretreating agent which has a bleaching, wetting and stabilizing action and provides a good washing and sequestering effect.

Before textile material can be dyed, it has to be suitably pretreated, for which classic operations such as desizing, degreasing/cleaning and bleaching are employed. Various chemical products are used, examples being wetting agents, detergents, bleachers, stabilizers, complexing agents or defoamers. These pretreatment steps are often combined into a single operation, in which case all-in-one products are employed. These products, which are usually aqueous compositions, should provide good wettability of textile material for pretreatment and good rewettability for subsequent dyeing while at the same time being very low in foam, since foam is a nuisance in batchwise jet equipment.

EP 1 092 804 discloses an aqueous composition for the pretreatment of fibre materials which comprises sulphonate salts or polyhydric alcohols and ethoxylated/propoxylated alcohols. Owing to the surfactant composition, however, a disadvantageously large amount of solubilizer (sodium cumenesulphonate or 1,5-methylpentanediol has to be used. The disclosed mixture, moreover, although not very prone to foaming, still foams too much for many textile-finishing machines.

The present invention accordingly has for its object to provide a stable low-viscosity all-in-one textile-pretreating agent which has low solubilizer requirements and yet meets the requirements described above.

It has now been found that, surprisingly, a mixture of certain alkoxylates or their phosphoric esters and further additives such as for example sequesterants, stabilizers or defoamers has the desired performance profile. This mixture combines all desired requirements like no other commercially available product.

The invention thus provides an aqueous mixture comprising
A) at least one alkoxylate of the formula (I) R′—O—(CH₂—CHR²—O)—CH₂—CH₂—OH or its phosphoric ester, wherein
   R¹ is a linear or branched C₆-C₁₉-alkyl radical,
   R² is hydrogen, methyl or ethyl, and
   n has an average value of 3 to 11;
B) at least one hydroxy carboxylic acid in simple form or as a polyoligo hydroxy carboxylic acid or salts thereof or a polyacrylate or a phosphonate or salts thereof or any mixtures therefrom,
C) an aromatic sulphonation or sulphination or sulphation product or salts thereof,
D) an alkaline earth metal salt,
   and also optionally further additives.

The alcohols underlying the alkoxylates may also consist of any desired mixtures of linear and branched alcohols.

Preference is given to mixtures wherein
R¹ is a linear or branched C₈-C₁₅-alkyl radical,
R² is hydrogen or methyl,
n has an average value of 5 to 9;
B is citric acid or sodium gluconate or an α-hydroxy polyacrylate or ATMP, HEDP, DTPMPA, EDTMPA or PBTC or salts of these phosphonates or any mixture therefrom,
C is cumenesulphonic acid or naphthalenesulphonic acid or an alkali metal/ammonium salts thereof, and
D is magnesium chloride, magnesium sulphate, calcium chloride or calcium sulphate.

The phosphonates referred to by their well-known abbreviations are:
ATMP=Aminotri(methylenephosphonic acid), CAS No. 6419-19-8;
HEDP=1-Hydroxyethylene-1,1-diphosphonic acid, CAS No. 2809-21-4;
DTPMPA=Diethylenetriaminepenta(methylenephosphonic acid), CAS No. 15827-60-8;
EDTMPA=Ethylenediaminetetra(methylenephosphonic acid), CAS No. 1429-50-1;
PBTC=2-Phosphonobutane 1,24-tricarboxylic acid, CAS No. 37971-36-1.

DTPMPA and ATMP were found to be particularly suitable.

In a mixture which is likewise very suitable
R¹ is a linear or branched C₁₂-C₁₅-alkyl radical,
R² is hydrogen or methyl,
n has an average value of 6 or 7; and
B is citric acid or sodium gluconate or DTPMPA or any mixture therefrom,
C is cumenesulphonic acid or an alkali metal/ammonium salt thereof, and
D is magnesium chloride or magnesium sulphate.

Particular preference is given to the above mixture when
B is a mixture of citric acid and sodium gluconate,
C is sodium cumenesulphonate, and
D is magnesium chloride.

Advantageous properties are shown by a mixture comprising
A) two different alkoxylates of the formula (I),
   A1) wherein
      R¹ is a branched C₆-C₁₄-alkyl radical,
      R² is hydrogen, methyl or ethyl, and
      n has an average value of 3 to 11; and
   A2) wherein
      R¹ is a linear or branched C₈-C₁₉-alkyl radical,
      R² is hydrogen, methyl or ethyl, and
      n has an average value of 3 to 10, and
B) at least one hydroxy carboxylic acid in simple form or as a polyoligo hydroxy carboxylic acid or salts thereof or a polyacrylate or a phosphonate or salts thereof or any mixtures therefrom,
C) an aromatic sulphonation or sulphination or sulphation product or salts thereof,
D) an alkaline earth metal salt,
   and also optionally further additives.

The combination of these two specific alkoxylates leads to particularly good washing, wetting and rewetting properties and also excellent whitenesses.

Very good properties are likewise shown by a mixture wherein in
A1) R¹ is a branched C₈-C₁₂-alkyl radical,
   R² is hydrogen or methyl, and
   n has an average value of 5 to 9; and in
A2) R¹ is a linear or branched C₁₀-C₁₇-alkyl radical,
   R² is hydrogen or methyl,
   n has an average value of 4 to 8, and
B is citric acid or sodium gluconate or an o-hydroxy polyacrylate or ATMP, HEDP, DTPMPA, EDTMPA or PBTC or salts of these phosphonates or any mixture therefrom,
C is cumenesulphonic acid or naphthalenesulphonic acid or an alkali metal/ammonium salts thereof, and
D is magnesium chloride, magnesium sulphate, calcium chloride or calcium sulphate.

Particular preference is given to a mixture wherein in
A1) R¹ is a branched C₁₀-alkyl radical,
   R² is hydrogen, and
   n has an average value of 7; and in
A2) R¹ is a linear or branched C₁₂-C₁₅-alkyl radical,
   R² is hydrogen,
   n has an average value of 6, and
B is citric acid or sodium gluconate or DTPMPA or any mixture therefrom,
C is cumenesulphonic acid or an alkali metal/ammonium salt thereof, and
D is magnesium chloride or magnesium sulphate.

Very particular preference is given to this mixture when
B is a mixture of citric acid and sodium gluconate,
C is sodium cumenesulphonate, and
D is magnesium chloride.

A mixture wherein
A1) is an alkoxylate of a linear or branched C₁₀-alcohol or mixtures thereof having on average 8 ethylene oxide units and 1 propylene oxide unit, and
A2) is an alkoxylate of a linear or branched C₁₂-C₁₅-alcohol having on average 7 ethylene oxide units, and
B is a mixture of citric acid and sodium gluconate,
C is sodium cumenesulphonate, and
D is magnesium chloride,
   is likewise very preferable.

Useful further additives include for example foam-suppressing components or defoamers, although the present mixture is already very low in foam. A particularly useful foam-suppressing component is 2-ethylhexylisononanonamide (0.1 % to 1.0% by weight, preferably 0.5% by weight).

Component A (or the sum total of A1 and A2) is present in the aqueous solution in a concentration of 1% to 40%, preferably of 7% to 20% and more preferably of 14% to 20% by weight, based on the entire aqueous solution. Component B is used in a concentration of 1% to 20%, preferably of 2% to 10% and more preferably of 3% to 8% by weight. Components C and D are each used in a concentration of 0.1% to 10%, preferably of 0.4% to 5% and more preferably of 0.6% to 2.5% by weight.

More concentrated solutions can also be prepared, in which case the ratio of the individual components to each other remains the same.

The mixture is prepared by simply mixing the components. The individual components are known compounds and are commercially available.

The mixture of the present invention is a storage-stable liquid which is miscible with water in any proportion and of low viscosity and therefore usable in automatic metering pump systems. The present mixture is extremely low in foam, exhibits good wetting power and good rewettability, especially with regard to cotton, which was bleached therewith in a peroxide bleach. It further has a good washing action and a good sequestering action, particularly with regard to iron, manganese, alkaline earth metals and heavy metals. The mixture has a peroxide-stabilizing action and is highly resistant to alkali. The whitenesses attainable in a bleaching operation using the product described are surprisingly high. The surprisingly low amount of solubilizer constitutes a further useful technical advantage.

Owing to its specific properties, the mixture of the present invention is suitable for all fibre species on machines which can lead to foam problems. Its use is advisable particularly whenever a combination of good wetting, washing and stabilizing properties in a single product is demanded for efficient and economical processing. Examples of some fibres are cotton, linen, wool, wool-polyester, viscose or ramie fibres.

Fields of use are batch processes, for example at 1-4% of the mixture according to the present invention and 0-2% of a secondary alkane- or alkenylsulphonate, a sulphated alkenyl carboxylic acid or a sulphate or sulphonate of a derivatized olefin (for example Humectol® C fl. hc, Clariant) on jiggers, reel becks, overflows, jets and other circulation-dyeing machines, or continuous processes from a long liquor (under-liquor bleaching) at for example 2-6 ml/I of the present mixture.

The examples which follow illustrate the invention. All percentages are to be understood as weight %.

Recipe Example for 100% Cotton Knit

Scouring for Dyeing Dark Shades

Scouring (liquor ratio 8:1-10:1**)

1-3 m/l] of inventive mixture

2-3 m/l of aqueous sodium hydroxide solution 50%

Add chemicals preferably at 40° C., heat to 98° C. at 2-4° C./min, treat at boil for 40 min or at 120° C. for 5 min, cool down to 70° C., drop bath.

Rinsing

Rinse hot at 80° C. for 10-15 min, drop bath, rinse cold for 10-20 min with 0.5-1 ml/l of a mineral-acid-free neutralizing agent such as citric, maleic, acetic, formic, lactic or phosphonic acid (for example Sirrix® NE liquid, Clariant), drop bath.

Dyeing

as usual

Recipe Example for 100% Cotton Knit

Hydrogen Peroxide Bleach

Peroxide bleach (liquor ratio 8:1-10:1**)

1-3 ml/l of inventive mixture

2-3 ml/l of hydrogen peroxide 50%

1.5-2.5 ml/l of aqueous sodium hydroxide solution 50%

Add chemicals preferably at 40° C., heat to 98° C. at 2-4° C./min, treat at boil for 45 min or at 110° C. for 15 min, cool down to 70° C., drop bath.

Rinsing

Rinse hot at 80° C. for 10-15 min, drop bath, rinse cold for 10-20 min with 0.5-1 ml/l of a mineral-acid-free neutralizing agent such as citric, maleic, acetic, formic, lactic or phosphonic acid (for example Sirrix® NE liquid, Clariant), drop bath.

Bio Removal of Residual Peroxide

Treat 0.3-0.4 ml/l of an aqueous formulation of a catalase (for example Bactosol® ARL liquid conc., Clariant) at 30-55° C. for 10-15 min, pH 6-8.5, fabric ready for dyeing, proceed without dropping bath.
** When a very short liquor ratio is chosen, 0.3-1 mil of a gliding enhancer such as mixtures of a wax with an alcohol alkoxylate and a polyethylene glycol derivative or such as diverse mineral oils, ester oils, long-chain carboxylic acids or paraffin waxes should be used (for example Imacol® C liquid, Clariant).

A typical bleaching cycle for cellulosic fibres will now be described as an example of a textile-pretreating process.

A typical classic example of preparation for dyeing 100% cotton woven fabric, cited as prior art in EP 1 305 469, comprises:

Exhaust Process

a) Bath composition
0.5-2.0 g/l of wetting agent/detergent: nonionic or anionic surfactants
0.3-0.6 g/l of peroxide stabilizer: organo-phosphate based (e.g. diethylenetriaminepentamethylene-phosphoric acid (DTPMP) and/or amino-organic acid based (e.g. diethylene-triaminepentaacetic acid (DTPA)) and/or polyacrylic acid based (e.g. sodium salt of gluconic acid) and/or silicate based and/or alkaline earth metal salts (e.g. MgCl₂)

These above two components can be replaced by 1-4 g/l of the mixture according to the present invention.

1.5-3.0 g/l of caustic soda (100%)

1.5-3.0 g/l of hydrogen peroxide (100%)

b) Typical Application

Cellulosic material is loaded into an exhaust dyeing machine or apparatus (e.g. jet dyeing machine, winch, pack dyeing machine, beam, etc.). The machine is filled with water and possibly with a wetting agent to produce a bath before a material load is introduced into the machine. The water amount is typically calculated based on the weight of the material load and expressed in a liquor ratio. A typical liquor ratio is 10:1, i.e. 10 l of liquid are used for 1 kg of fabric.

Subsequent to loading the machine, the remaining chemicals are added and the resulting bath is heated to a suitable temperature, typically 98° C. to 110° C. Depending on the construction of the machine /apparatus, the material and/or liquor are set in motion to ensure homogeneous and efficient pretreatment.

After a treatment time of 15-30 minutes, the bath is cooled and dropped, or drained. Multiple rinses and/or overflow washes of the cellulosic material are necessary to remove from the material impurities and especially residual alkalinity which otherwise would impair the efficiency of subsequent operations.

Alkalinity, typically provided by caustic soda, is considered necessary to activate the oxidizing component, hydrogen peroxide, and to saponify waxes and other fat-based cotton by-products allowing easy removal of these impurities. This pretreatment process for cellulosic material is commonly referred to as a bleaching cycle, which takes place prior to dyeing the material.

A more recent process for cellulosic or cellulosic-synthetic fibre blend substrate pretreatment which obviates or at least appreciably reduces the amount of rinsing required is disclosed in EP 1 305 469. The process is ideally used for pretreating cellulosic or cellulosic fibre blend material before it is dyed. Considerable amounts of water, energy and labour can be saved in the process. The process consists of the following steps: providing a vessel; providing a cellulosic or cellulosic-synthetic fibre blend substrate; providing a water bath; adding an active amount of an activating compound selected from the group consisting of salts of organic acids, organic amine derivatives, transition metals, adding an active amount of caustic soda; adding an active amount of hydrogen peroxide during a bleach cycle; heating the water bath to a temperature above 50 degrees Celsius during a predetermined time period; and dropping the bath. It is further possible to add an active amount of a wetting agent, of an abrasive and of a peroxide stabilizer.

It is in such a pretreatment process, illustrated here using cellulose as an example, that the mixture of the present invention is very useful, and in the process of EP 1 305 469 it replaced the wetting agent and the peroxide stabilizer together (use of 1-4 g/l).

The test methods carried out are known to one skilled in the art; just two may be recited by way of example:

Ross-Miles Foam Test

The foam volume is measured after a certain amount of liquid has been poured from a certain height, instantly and after a one minute wait.

A 1000 ml graduated cylinder 60 mm in internal diameter and 430 mm in internal height is used. The test liquid is allowed to pour out from a 2 1 separating funnel through a capillary 70 mm in length and 2 mm in internal diameter from a height of 600 mm, measured from the outlet of the capillary above the floor of the cylinder.

500 ml of the solution to be tested are filled into the separating funnel and allowed to flow out into the graduated cylinder through the capillary-controlled efflux rate of about 0.17 l/min. As soon as the entire solution has flowed out, a stopwatch is started and the entire volume (foam volume plus solution volume) is read off the cylinder scale. The reading is repeated after one minute.

The alkaline foam performance is tested using a surfactant concentration of 2 g/l in 2° Be—NaOH solution in demineralized water, with 20 Be—NaOH being equivalent to 12 g/l of NaOH solid of 30 ml/l of NaOH 36°Be. The test temperature is 20 to 25° C.

Alkaline Wetting

This test method determines the number of seconds a fabric sample takes to sink to the bottom of a glass beaker 1 l in content, 14 cm in height and 10 cm in diameter in a surfactant solution. The fabric sample used is a cotton test cloth, article 501.2 at 490 g/m², from EMPA Testmaterialien AG of St. Gallen, Switzerland. Circularly round discs 3.5 cm in diameter are die cut out of this cloth and dipped with a special holder into the surfactant solution. The wetting action is tested in 2° Be—NaOH at 25° C.

Alkali Stability Using NaOH

This test method determines in the presence of how much aqueous sodium hydroxide solution the product is stable.

Surfactants have to have a certain stability to aqueous sodium hydroxide solution in order that impeccable operation is ensured in the textile industry in relation to processes such as for example scouring, mercerizing, bleaching.

What is tested is the alkali stability of 5 g/l of surfactant, 100 ml of liquor are made up in each case. The test takes place at room temperature 20-25° C. The required amount of aqueous sodium hydroxide solution is weighed into a glass beaker and made up to 95 ml with demineralized water. 5 ml of a 10% surfactant solution are added to the alkali batches with stirring. The glass beakers are left to stand at room temperature for 24 hours without stirring.

The solutions are tested for their stability after 24 hours. Creaming and precipitates are to be noted in particular, cloudiness without visible deposits is permissible. What is to be ascertained is the concentration in which the surfactant is still stable. Alkali stability is reported in X° Be—NaOH.

### EXAMPLE 1

An aqueous mixture was tested in accordance with the present invention, containing as component Al 7.4% of an alkoxylate of a linear or branched C₁₀-alcohol or mixtures thereof having on average 8 ethylene oxide units and I propylene oxide unit and containing as component A2 7.4% of an alkoxylate of a linear or branched C₁₂-C₁₅-alcohol having on average 7 ethylene oxide units. The further components were 3.6% of sodium gluconate, 1.5% of magnesium chloride heptahydrate, 2% of sodium cumenesulphonate at 40% in water, 1% of citric acid and 0.05% of defoamer.

### COMPARATIVE EXAMPLE 1

A composition as described in EP 1 092 804 was tested correspondingly. This mixture will hereinafter be referred to as “comparison 1”.

Performance Tests

The two mixtures were tested for their usefulness as textile-pretreating agents, with the following results:

| | | | Foam | Wetting | Wetting | Cotton JET- | |
|---|---|---|---|---|---|---|---|
| | TS content | Foam RM [ml] | continuous. | neutral | alkaline | bleach: CIE | Dilution with |
| Designation | [%] | neutral | method [ml] | 2 g/l [s] | 2 g/l [s] | (whiteness) | H₂O 1:1 |
| Example 1 | 20 | 40 | 50 | 85 | 90 | 69 | stable |
| Comparison 1 | 17 | 80 | 150 | 120 | 120 | 67 | unstable |

TS = dry solids content (measured with Mettler IR dryer);
RM = Ross-Miles method (DIN 53902-2)

The inventive mixture shows lower values in foaming and likewise lower, i.e. superior, values in wetting, the achieved whiteness is higher, and it is dilutable with water, unlike the comparative product.

### EXAMPLE 2

An aqueous mixture was tested in accordance with the present invention, containing as component Al 10% of an alkoxylate of a linear or branched C₁₀-alcohol or mixtures thereof having on average 8 ethylene oxide units and 1 propylene oxide unit and containing as component A2 10.0% of an alkoxylate of a linear or branched C₁₂-C₁₅-alcohol having on average 7 ethylene oxide units. The further components were 5% of sodium gluconate, 1.8% of magnesium chloride heptahydrate, 7% of sodium cumenesulphonate at 40% in water, 1.10% of citric acid monohydrate, 0.15% of defoamer and 0.50% of 2-ethylhexylisononanonamide.

The comparative substance taken was again “comparison 1” from the last Example 1 and also as “comparison 2” an aqueous mixture consisting of a fatty alcohol ethoxylate, gluconate and a solubilizer.

Performance Tests

The inventive mixture and also the two comparative products were tested in various well-known methods for their usefulness as textile-pretreating agent, with the following results:

Hydrogen Peroxide Bleach

15 min at 110° C.

Material: 100% cotton fabric

Liquor ratio: 9:1

TABLE 2
Formulation and results of hydrogen peroxide bleach

| | Formulation | | | |
|---|---|---|---|---|
| | 1 | 2 | 3 | |
| Example 2 | 1.1 | | | ml/l |
| Comparison 2 | | 1.1 | | ml/l |
| Comparison 1 | | | 1.1 | ml/l |
| H₂O₂ 50% | 2.2 | 2.2 | 2.2 | ml/l |
| NaOH 50% | 1.7 | 1.7 | 1.7 | ml/l |

| Results | 1 | 2 | 3 |
|---|---|---|---|
| CIE whiteness | 67.5 | 66.0 | 67.3 |
| Absorption in mm | 37 | 33 | 34 |
| Peroxide residue in % | 14 | 13 | 15 |

The inventive formulation shows the best whiteness and the best absorption value, i.e. the best rewettability.

TABLE 3
further performance tests

| | Alkali stability | Alkaline | Foam RM [ml] |
|---|---|---|---|
| Formulation | 5 g/l of ^{o}Be—NaOH | wetting [s] | alkaline start/1 min |
| Example 2 | 7 | 142 | 25/5 |
| Comparison 1 | 6 | 209 | 50/50 |
| Comparison 2 | 1 | 90 | 50/20 |

Alkaline wetting and the Ross-Miles foam test were carried out with 1.1 ml/l of the test product, with 2.2 ml/l of H₂O₂ 50%, with 2.2 ml/l of NaOH 50%. Inventive Example 2 shows the highest alkali stability, being only exceeded by Comparison 1 in alkaline wetting, and has by far the lowest foaming when tested under Ross-Miles.

Washtest Neutral

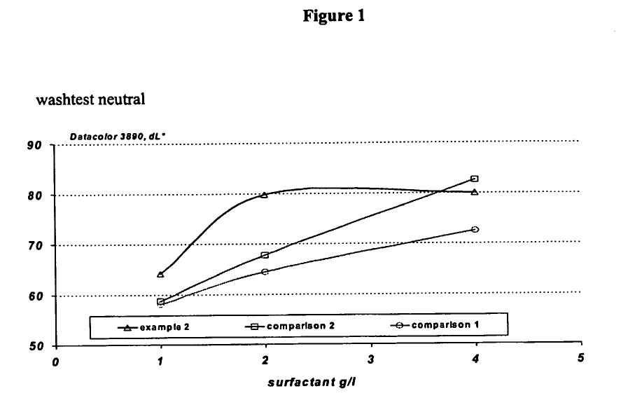

FIG. 1 shows the results of a washtest at pH 7 after 30 minutes at 50° C. on EMPA soiled cotton cloth, article No. 107. Used at just 2 g/l, Inventive Example 2 provides distinctly higher lightening, i.e. cleaning, of the soiled cloth than the comparative formulations.

Washtest Alkaline

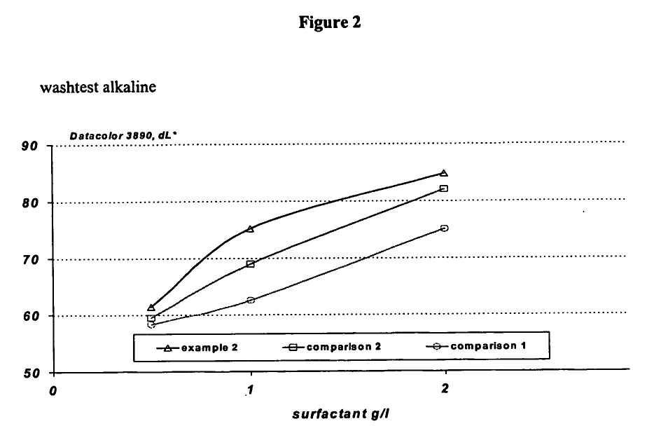

FIG. 2 shows the results of a washtest at pH 8.5 after 30 minutes at 50° C. on EMPA soiled cotton cloth. Here too Inventive Example 2 provides distinctly higher lightening, i.e. cleaning, of the soiled cloth than the comparative formulations.

Alkali Stability Test

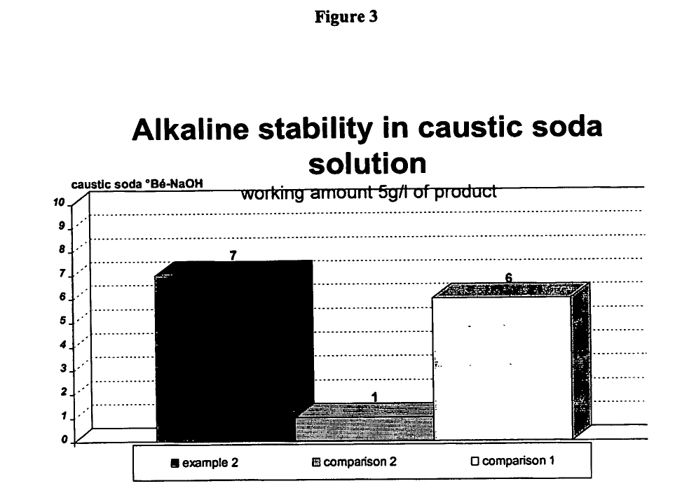

FIG. 3 shows that here too the inventive mixture possesses the best alkali stability.

1. An aqueous mixture comprising;
A) at least one alkoxylate of the formula (I)
R′—O—(CH₂—CHR²—O)ₙ—CH₂—CH₂—OH formula (I)
or its phosphoric ester,
wherein
R¹ is a linear or branched C₆-C₁₉-alkyl radical,
R² is hydrogen, methyl or ethyl, and
n has an average value of 3 to 11;
B) at least one compound selected from the group consisting of a hydroxy carboxylic acid in simple form, polyoligo hydroxy carboxylic acid a salt of a hydroxy carboxylic acid in simple form, a salt of a polyoligo hydroxy carboxylic acid, a polyacrylate, phosphonate, a polyacrylate salt, a phosphonate salt and mixtures thereof
C) an aromatic sulphonation, esulphination or sulphation product or salts thereof, and
D) an alkaline earth metal salt.

2. An aqueous mixture according to claim 1 wherein
R¹ is a linear or branched C₈-C₁₅-alkyl radical,
R² is hydrogen or methyl,
n has an average value of 5 to 9;
B is citric acid, sodium gluconate, α-hydroxy polyacrylate, ATMP, HEDP, DTPMPA, EDTMPA, PBTC, salts of these phosphonates or a mixture thereof,
C is cumenesulphonic acid, enaphthalenesulphonic acid an alkali metal salt of cumenesulphonic acid, an alkali metal salt of naphthalenesulphonic acid, an ammonium salt of cumenesulphonic acid, or an ammonium salt of naphthalenesulphonic acid, and
D is magnesium chloride, magnesium sulphate, calcium chloride or calcium sulphate.

3. An aqueous mixture according to claim 1 wherein
R¹ is a linear or branched C₁₂-C₁₅-alkyl radical,
R² is hydrogen or methyl,
n has an average value of 6 or 7;
B is citric acid, sodium gluconate, DTPMPA or a mixture thereof,
C is cumenesulphonic acid an alkali metal salt of cumenesulphonic acid or an ammonium salt of cumenesulphonic acid, and
D is magnesium chloride or magnesium sulphate.

4. An aqueous mixture according to claim 3 wherein
B is a mixture of citric acid and sodium gluconate,
C is sodium cumenesulphonate, and
D is magnesium chloride.

5. An aqueous mixture according to claim 1 comprising two different alkoxylates of the formula (I), A1) and A2)
A1) wherein
R¹ is a branched C₆-C₁₄-alkyl radical,
R² is hydrogen, methyl or ethyl, and
n has an average value of 3 to 11; and
A2) wherein
R¹ is a linear or branched C₈-C₁₉-alkyl radical,
R² is hydrogen, methyl or ethyl, and
n has an average value of 3 to 10.

6. An aqueous mixture according to claim 5 wherein in
A1) R¹ is a branched C₈-C₁₂-alkyl radical,
R² is hydrogen or methyl, and
n has an average value of 5 to 9;
and in
A2) R¹ is a linear or branched C₁₀-C₁₇-alkyl radical,
R² is hydrogen or methyl,
n has an average value of 4 to 8, and
B is citric acids sodium gluconate, an α-hydroxy polyacrylate or ATMP, HEDP, DTPMPA, EDTMPA, PBTC or salts of these phosphonates or a mixture thereof,
C is cumenesulphonic acids enaphthalenesulphonic acid an alkali metal salt of cumenesulphonic acid, an alkali metal salt of naphthalenesulphonic acid, an ammonium salt of cumenesulphonic acid or an ammonium salt of naphthalenesulphonic acid, and
D is magnesium chloride, magnesium sulphate, calcium chloride or calcium sulphate.

7. An aqueous mixture according to claim 5 wherein
A1) R¹ is a branched C₁₀-alkyl radical,
R² is hydrogen, and
n has an average value of 7; and in
A2) R¹ is a linear or branched C₁₂-C₁₅-alkyl radical,
R² is hydrogen,
n has an average value of 6, and
B is citric acids sodium gluconate. DTPMPA or a mixture thereof,
C is cumenesulphonic acid, an alkali metal salt of cumenesulphonic acid or an ammonium salt of cumenesulphonic acid, and
D is magnesium chloride or magnesium sulphate.

8. An aqueous mixture according to claim 5 wherein
A1) is an alkoxylate of a linear or branched C₁₀-alcohol or mixtures a mixture thereof having on average 8 ethylene oxide units and 1 propylene oxide unit, and
A2) is an alkoxylate of a linear or branched C₁₂-C₁₅-alcohol having on average 7 ethylene oxide units, and
B is a mixture of citric acid and sodium gluconate,
C is sodium cumenesulphonate, and
D is magnesium chloride.

9. An aqueous mixture according to claim 7 wherein
B is a mixture of citric acid and sodium gluconate,
C is sodium cumenesulphonate, and
D is magnesium chloride.

10. An aqueous mixture according to claim 1, wherein said component A has a concentration of 1 % to 40% by weight, said component B has a concentration of 1% to 20% by weight, said components C and D each have a concentration of 0.1% to 10% by weight, based on the entire aqueous mixture.

11. An aqueous mixture according to claim 1, wherein the concentration of component A 7% to 20% by weight, of component B is 2% to 10% by weight and each of components C and D is 0.4% to 5% by weight, based on the aqueous mixture.

12. An aqueous mixture according to claim 1, wherein the concentration of component A is 14% to 20% by weight, of component B is 3% to 8% by weight and each of components C and D 0.6% to 2. 5% by weight, based on the aqueous mixture.

13. An aqueous mixture according to claim 1, further comprisinn a foam-suppressing component and defoamer.

14. A textile pretreated with the aqueous mixture according to claim 1.

15. A process for pretreating a textile comprising the steps of
setting a liquor ratio of 5:1 to 20:1, adding the textile to a treatment bath
in a first heating step, heating the treatment bath to 25-60° C.,
adding an aqueous mixture in accordance with claim 1 to the treatment bath in an amount of 0.5-8 ml/l,
adding hydrogen peroxide 50% to the treatment bath in an amount of 1-20 ml/l,
adding aqueous sodium hydroxide solution 50% to the treatment bath in an amount of 1-10 m/l,
in a second heating step, heating the treatment bath to 8-130° C.,
holding the temperature of the second heating step for 15-90 minutes,
cooling and dropping the treatment bath,
optionally hot rinsing the textile at 50-100° C.,
optionally cold rinsing the textile and
optionally dropping the rinsing bath.

16. A process for cellulosic or cellulosic-synthetic fibre blend pretreatment comprising steps of
providing a vessel;
providing a cellulosic or cellulosic-synthetic fibre blend substrate;
providing a water bath;
adding an aqueous mixture according to claim 1,
optionally adding an active amount of an activating compound selected from the group consisting of salts of organic acids, organic amine derivatives, transition metal salts or transition metal complexes,
adding an active amount of caustic soda to obtain a starting bath having an alkaline pH;
adding an active amount of hydrogen peroxide to the starting bath;
heating the starting bath to a temperature of 80-130° C.;
optionally cold or warm rinsing the cellulosic or cellulosic-synthetic fibre blend substrate, and
optionally adding catalase to the cellulosic or cellulosic-synthetic fibre blend substrate.

17. A process according to claim 16, wherein the aqueous mixture is added in a concentration of 0.5-4 g/l.

18. A process according to claim 15, wherein the liquor ratio is 8:1 to 10:1.

19. A process according to claim 15, wherein the heating step further comprises heating the treatment bath 30-50° C.

20. A process according to claim 15, wherein the amount of the aqueous mixture added to the treatment bath is 1-4 ml/l.

21. A process according to claim 15, wherein the amount of hydrogen peroxide added to the treatment bath is 2-3 ml/l.

22. A process according to claim 15, wherein the amount of sodium hydroxide solution 50% added to the treatment bath is 1.5-3.5 ml/l.

23. A process according to claim 15, wherein in the second heating step the temperature is 95-100° C.

24. A process according to claim 15, wherein the temperature of the second heating step is held for 40-50 minutes.

25. A process according to claim 15, wherein the hot rinsing step occurs at a temperature between 70 and 90° C.

26. A textile pretreated in accordance with the process of claim 15.

27. A cellulosic or cellulosic-synthetic fibre blend substrate pretreated in accordance with the process according to claim 16.
